(19) United States
(12) Patent Application Publication
(10) Pub. No.: US 2017/0329394 A1
(43) Pub. Date: Nov. 16, 2017

(54) VIRTUAL AND AUGMENTED REALITY SYSTEMS

(71) Applicant: Benjamin Lloyd Goldstein, Los Angeles, CA (US)

(72) Inventor: Benjamin Lloyd Goldstein, Los Angeles, CA (US)

(21) Appl. No.: 15/587,839

(22) Filed: May 5, 2017

Related U.S. Application Data
(60) Provisional application No. 62/335,688, filed on May 13, 2016.

(51) Int. Cl. G06F 3/01

(52) U.S. Cl. CPC G06F 3/011; G06F 3/017

(57) ABSTRACT

A more effective, intuitive, and accessible 3d operating system to navigate, create, explore, share, produce, and be effective in virtual, augmented, and mixed reality applications. A spatial utility model that allows for functions and operability through multiple dimensions of spatial actions and data interactivity for Virtual/Augmented/Mixed reality applications, by way of providing defined spatial protocols, actions, procedures, and relationships for interfacing. These functions can be expanded, connected, and enhanced capable experiences of the body to applications, virtual data, interactivity, and media consumption.

### CROSS-REFERENCE TO RELATED APPLICATION

This application claims the benefit of U.S. Provisional Application No. 62/335,688 filed on May 6, 2016, entitled “Mixed Reality Studio Utility”, by inventor Benjamin Lloyd Goldstein, the contents of which are incorporated herein by reference as though set forth in their entirety.

### BACKGROUND

It would be desirable to have a spatial operating system architecture with associated software that acts as a framework which allows for enhanced user interactivity with digital content by means of sophisticated spatial behaviors in virtual and augmented reality. Furthermore, it would also be desirable to have a system and software that is capable of automating the proportion, visibility, scale, layout, timing, and other variables essential for usability and legibility of the content experienced in space.

Still further, it would be desirable to have a system and software that can streamline the deployment of this framework so that other software developers can use the spatial utilities and functions described in this invention for their own application development, customized operating environments, spatial websites, content delivery systems, and more. Currently, no such framework exists.

Therefore, there currently exists a need in the virtual and augmented reality industry for a system that dynamically organizes digital content and interactive elements into a hierarchical spatial architecture format that leads to enhanced legibility, experience, user interactivity and abilities.

This utility would allow developers to use the spatial utility tools to build their own interactive spatial experiences and commands into their software, deploy specific content delivery to users, and build on top of the dynamic spatial functions as a base layer spatial operating framework for virtual and augmented reality.

The system of the present disclosure may also solve the problem of having to individually place augmented reality content in ever changing spaces, and will allow for a more seamless integration of multiple spatial contexts, and multiple augmented reality operating formats.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

The system disclosed herein may be a more effective, intuitive, and accessible 3d operating system to navigate, create, explore, share, produce, and be effective in virtual, augmented, and mixed reality applications.

This disclosure is related to a spatial utility model that allows for functions and operability through multiple dimensions of spatial actions and data interactivity for Virtual/Augmented/Mixed reality applications, by way of providing defined spatial protocols, actions, procedures, and relationships for interfacing. These functions can be expanded, connected, and enhanced capable experiences of the body to applications, virtual data, interactivity, and media consumption.

Current applications for Mixed Reality are primarily utilizing two-dimensional elements placed within the space. This utility allows developers to use tools to build interactive frameworks and gestures into their software and interfaces.

The system of the present disclosure is an improvement over existing technology because current applications for Mixed Reality are primarily utilizing two-dimensional elements placed within the space. This utility allows developers to use tools to build interactive frameworks and gestures into their software and interfaces.

The system of the present disclosure would benefit anyone who uses mobile technology to empower them to organize, create, share, produce, publish, and consume media and applications. This may include but is not limited to: inventors, consumers of media, creators of media, users that are active on social media, gamers, corporations, media outlets, content distribution channels, technology companies, application developers, architects, film makers, film directors, mathematicians, scientists, explorers, artists, game developers, doctors, hospitals, etc. Specific uses include, but are not limited to:
Content distribution networks/social media/YouTube content creators/early adopter
Commerce/Marketplaces/Architecture
Interact with followers, users, and channels in more intimate and personal ways
Gamers: Full interactive reality gameplay
Long distance communication: FaceTime/Hangouts/Skype/etc.
Productivity Nerds: new ways of storing data, visualization, etc.
Other Areas: Movies, TV, Mobile

The present system may use divisions of space, spatial grids, orders of proximity, geometric boundaries, lattices, dynamic scalar relationships, relationships to the body, interactive energy fields, resonance dynamics, cymatic phenomena, gesture controls, gravity simulations, particle simulations, emotional data, and/or mathematical domains with spatial, temporal, structural, and hierarchical relationship to each other, the user's body, and the surrounding environment for collision detection, operational tasks, content placement, creation, consumption, distribution, and other interactive tasks. The order of the relationship is to utilize families of functionally relatable geometries through a proprietary directive protocol.

The present disclosure relates to both a system and associated software. With respect to the system, it is best characterized as a Spatial Operating System with Dynamic Spatial Utility Model for Virtual and Augmented Reality.

The core components that together make up the architecture of the system may be: A User, augmented reality or virtual reality interface devices, digital user interface elements, user interactions and/or gestures, a dynamic utility model for inter-operable functions and component behaviors of the digital elements in space, digital content modules, input and output streams, sensory data, sense data, location data, 3d spatial data of a user's environment, biometric data from the user's body, and artificial intelligence algorithms.

Generally speaking, these components are structured such that the user commands the operating system from within virtual and/or augmented reality to achieve desired outcomes, processes, and effects in digital spatial computing. This architecture allows the system to execute commands from the user, understand the user's preferences, interpret the available space around the user, and facilitate automatic, responsive, and/or curated spatial configurations of content and interactive elements in space around the user.

In order to accomplish desired objectives the system employs certain associated software that dynamically displays and animates content and interactive elements in reference to the user's body, physical objects, and/or the surrounding environment. This software allows the user to maintain a fluid and flexible relationship with the digital operating environment in a way that is inherently ordered in spatial organization, hierarchy, and process. This also provides new ways for customized experiences and workflows, either user-defined, social, procedural, and/or artificially suggested from the software as it learns from the user's patterns to anticipate behaviors.

In another embodiment, the system of the present disclosure may provide a functioning utility for the interpretation and utilization of the spatial features of one's surrounding environment for appropriate programmable elements of augmented reality experiences. The system and the related software evaluates and interprets a spatial context to make decisions about where spatial content modules and interactive elements should be placed relative to the user(s). After scanning the raw spatial data from the context, the software processes an algorithm that interprets surfaces and depths, and categorizes them appropriately. The program then saves the modules and integrates the content and functionality based on user parameters and operational modes. The program can include flexibility and slight fluidity and randomness controls to embody a more organic content organization experience. As the user moves around in the space, the fixed modules will remain fixed to the space. When a user leaves a space, some will detach from the fixed locations and integrate into his content aura, following in a non-obtrusive way, and will re-organize themselves in the next spatial setting. This embodiment is an improvement over existing technology because it may utilize spatial scanning but still rely on the user to place content modules that they can affix to their environment. This would be an improvement over that because it would essentially lay out the content for the user faster and more intelligently than the user could, so the user can continue to focus on interacting with the content. This embodiment might benefit anyone who uses Augmented Reality applications in a mobile or home setting would benefit from this invention. The effective result is users will move through spaces fluidly while maintaining the ability to access and operate within their augmented content in a way that is seamless, intuitive, unobtrusive, and intelligently based on procedural rules of form, scale and function.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of the system showing hero-centric spatial utility specification of proxemics and fields of operational effectiveness.

FIG. 2 is an illustration of one embodiment of the system showing a spatial utility model.

FIG. 3 is an illustration of one embodiment of the system showing basic hierarchy of structural lattice with content delivery modules.

FIG. 4 is an illustration of one embodiment of the system showing expansion from node based cluster.

FIG. 5 is an illustration of one embodiment of the system showing a proxemics utility model.

FIG. 6 is an illustration of one embodiment of the system showing another proxemics utility model.

FIG. 7 is an illustration of one embodiment of the system showing fractal scalar transitions.

FIG. 8 is an illustration of one embodiment of the system showing primary and sub structural lattice.

FIG. 9 is a flow diagram of one embodiment of an architectural interface recognition.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

### Spatial Operating System with Dynamic Spatial Utility Model for Virtual and Augmented Reality

Critical System Elements

User—The participant who is experiencing the Mixed Reality Experience, and/or is commanding the Spatial Operating System.

Meta ID—The End User's protected identification component that is stored and used to identify and collect data from the User by the system.

Mixed Reality Experience—A virtual reality or augmented reality experience. Also defined as the immersive or expansive juxtaposition or montage of sensory content originating from various real or virtual sources that combine to create a summation experience for the User. This experience may have several effects including but not limited to: the enabling of productivity, communication, creation, social interaction, digital identity, learning, alternate states of presence, entertainment, interactivity, mobility, operability, translational awareness, meditation, prayer, or viewership, among others.

Virtual or Augmented Reality Interface Device—The interface with which the participant is experiencing the Mixed Reality Experience. This may be a Virtual Reality Head Mounted Display, Augmented Reality Headset or Glasses, or any variation of sensory input into the senses of the user which results in the Mixed Reality Experience. This may include technologies that bypass external sensory equipment and internalize direct sensory input within the internal biological sensory system of the End User, including nascent neuro-input technology, or otherwise similar sensation delivery system.

Spatial Operating System—The software framework that allows the User to interact with the User Interface Elements through space and time for desired and unexpected outcomes within the Mixed Reality Experience.

Spatial Utility Model—The dynamic relationship of all elements of the software and their behaviors organized in time and space and for the purposes of executing the Spatial Operating System. This is defined through the elements and their behaviors in relation to each other, including their Spatial Mechanics. This utility also includes parameters for the input and output of data to the Virtual or Augmented Reality Interface Device, the internet, metaverse, servers, cloud computing, virtual graphics processors, or any other software or hardware that is useful or desired to connect to the Spatial Operating System.

Spatial Mechanics—Any actions, animations, or behaviors of elements of the system relative to themselves, each other, and/or the user; in an ordered or organic way, including but not limited to: grouping, packing, expanding, scaling, filtering, sorting, listing, floating, sliding, duplicating, copying, pasting, stacking, illuminating, melting, freezing, vaporizing, attracting, repelling, fading in & out, scrolling, extruding, any boolean commands, etc., and/or any commands useful to a 3d modeling software and the animation protocols executed to relate the objects to the User and each other.

Personal Tools—This may include any User Interface Elements for personal interaction from within the Mixed Reality Experience, which may be controlled by the End User. This could include elements for such activities as social interfacing, sharing, liking, archiving, tagging, photographing, saving, documenting, advertising, note taking, and/or any other actions enabled by third party applications or partners. Interactions within the metaverse or virtual internet for consuming, contributing, interacting, shopping, socializing and being a part of a live experience may be controlled through these User Interface Elements. This may or may not include avatars as well as other personal virtual identity content, preferences, settings, or artistic controls. In general, these are tools that modify and customize the experience for the End User in a way that enables them to express themselves in a way specific to the End User, and may be at times controlled in part or whole by the End User.

User Interface Elements—The elements within the Spatial Operating System that the End User interacts with directly or indirectly to operate several varying functions.

Proxemics
Horizontal
   Intimate distance for embracing, touching or whispering
      Close phase—less than 6 inches (15 cm)
      Far phase—6 to 18 inches (15 to 46 cm)
   Personal distance for interactions among good friends or family
      Close phase—1.5 to 2.5 feet (46 to 76 cm)
      Far phase—2.5 to 4 feet (76 to 122 cm)
   Social distance for interactions among acquaintances
      Close phase—4 to 7 feet (1.2 to 2.1 m)
      Far phase—7 to 12 feet (2.1 to 3.7 m)
   Public distance used for public speaking
      Close phase—12 to 25 feet (3.7 to 7.6 m)
      Far phase—25 feet (7.6 m) or more.
Vertical
   Dominance
   Sub-ordinance

Fields of Operational Effectiveness (Distances Where Certain Content is More Effective) (“PREVIC”)
Extrapersonal space: The space that occurs outside the reach of an individual.
Peripersonal space: The space within reach of any limb of an individual. Thus, to be “within arm's length” is to be within one's peripersonal space.
Pericutaneous space: The space just outside our bodies but which might be near to touching it. Visual-tactile perceptive fields overlap in processing this space. For example, an individual might see a feather as not touching their skin but still experience the sensation of being tickled when it hovers just above their hand. Other examples include the blowing of wind, gusts of air, and the passage of heat.

PREVIC further subdivide extrapersonal space into focal-extrapersonal space, action-extrapersonal space, and ambient-extrapersonal space. Focal-extrapersonal space is located in the lateral temporo-frontal pathways at the center of our vision, is retinotopically centered and tied to the position of our eyes, and is involved in object search and recognition. Action-extrapersonal-space is located in the medial temporo-frontal pathways, spans the entire space, and is head-centered and involved in orientation and locomotion in topographical space. Action-extrapersonal space provides the “presence” of our world. Ambient-extrapersonal space initially courses through the peripheral parieto-occipital visual pathways before joining up with vestibular and other body senses to control posture and orientation in earth-fixed/gravitational space. Numerous studies involving peripersonal and extrapersonal neglect have shown that peripersonal space is located dorsally in the parietal lobe whereas extrapersonal space is housed ventrally in the temporal lobe.

Threshold of Perception Limitation (Distances Where Certain Functions Lose Effectiveness)

User Gestures—Any relational physical action or biological data from the End User's body, or specific objects that command interaction with the Spatial Operating System. These may be movements and motions, explicit and subtle, of the End User's body. These may also include neurological gestures, thoughts, states of awareness, and or more subtle biological cues such as heart rate, temperature, or any movement of a biological system that could be useful for a relative action in the Spatial Operating System.

Hero-centric Volumes—Spatial Domains that are hierarchically related to certain systems or areas of the body, by either the receiving or transmitting of data, or connecting a user interface element to some field in a specific range of proximity to the body, and/or to certain parts of the body, and/or specific organs or energy centers of the body.

Primary Volumes—Spatial boundaries for containing data that are the primary focus of interaction at the specific moment of operation.

Non-Primary Volumes—Spatial boundaries for containing data that are not the primary focus of interaction at the specific moment of operation.

Buffer Volumes—Spatial Domains defined for the pre-loading of content in preparation for transition to a more primary zone of interaction.

Frozen Volumes—Spatial Domains defined for the containment of processes that are paused or in a frozen state, to be re-animated or interacted with later, or simply archived and stored.

Content Delivery Modules—Modules for the delivery of content experiences and interactions. Modules can be of varying scale: from embodiments as several organized cubes, polyhedra, or other geometries, or a cluster of small spheres, to larger scale fully immersive worlds and environments. Content Delivery Modules connect the End User to their content.

Sense Data—The data captured and recorded of all actions and sensations of the End User, which is uploaded to the cloud with the Meta ID.

Primary Structural Lattice—A multi-dimensional spatial grid and/or component network for spatial and time based functions that may be node-based. A system that organizes and displays User Interface Elements according to some form of overall spatial logic or grid.

Sub Structural Lattice—Similar to the Primary Structural Lattice, any subordinate and/or embedded system within the Primary Structural Lattice to further organize information at varying scales.

Incoming Streams—Content streams of data and/or information as they become present in the Spatial Operating System. Similar to a spatial inbox, or spatial stream.

Artificial Intelligence Architect—Artificial Intelligence system that automates responsive layouts, distributions, configurations, and proportions of the Spatial Operating System in a way that benefits the End User's ability to experience the system. Many factors may be present that may include but not be limited to: procedures that allow for increased comfort, productivity, sensation and/or functionality, among others. The software executes a procedure of spatial design methods involving but not limited to: scalar relationships, proxemics, fields of view, fields of reach, ambience, distribution of elements, layering of elements, composition of the scene, color, brightness, relation to the existing 3d spatial environment, as well as animation timing, geometric stylings, and transitioning styles. These would be similar to the services an Architect or Interior Designer would provide to a client to design a static physical space or a home. The AI Architect algorithm works with the End User's preferences, behaviors, and context, to constantly adapt responsive solutions for the End User's Mixed Reality Experience.

Artificial Intelligence Shaman—An artificial intelligence being or program that analyzes and interprets the Metaverse, forming an intimate knowledge of its workings, while simultaneously learning the character of the End User and his growth trajectory carried out over time in the system. He may use these insights to provide support, enhancements, suggestions, and any other augmentations to anticipated activities, moods, travel, connections, creation, growth, or any other behaviors within the system that the AI Shaman may have insight to that the End User could benefit from. Observation of the AI may be far reaching and should be best defined as anything perceivable by the AI that can be documented and interpreted to better understand the End User and form. Observations may include but not limited to: mood swings detected by various biometrics, movements in space, posture, breath, involuntary spasm, voice analysis, repetitive behaviors of any kind, reaction and responsiveness biometrics to certain data or interactive elements, layouts, content, or any combinations.

Software Executable Series

Incoming Streams (Spatial Inbox)—Notifications from all apps organized in a simultaneous vapor cloud of updates that can be completely turned off Particles as notifications

Thresholds of Privacy/Shielding (Golden Orb)

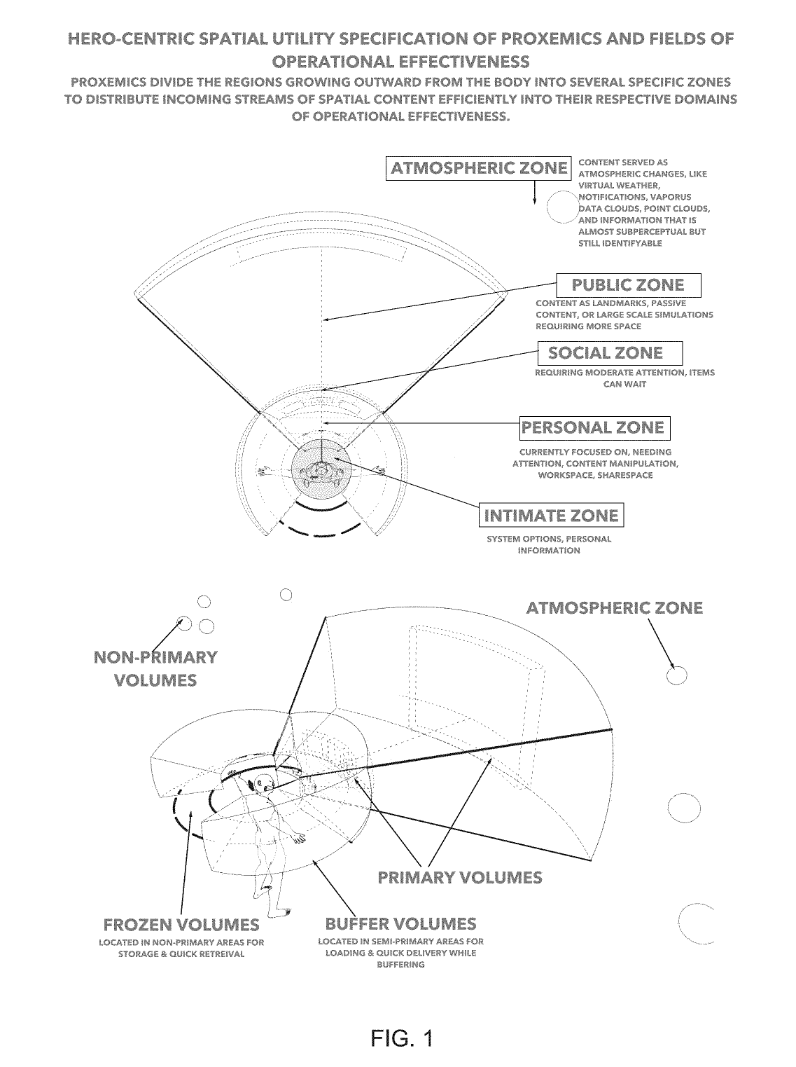

FIG. 1 is an illustration of one embodiment of the system showing hero-centric spatial utility specification of proxemics and fields of operational effectiveness.

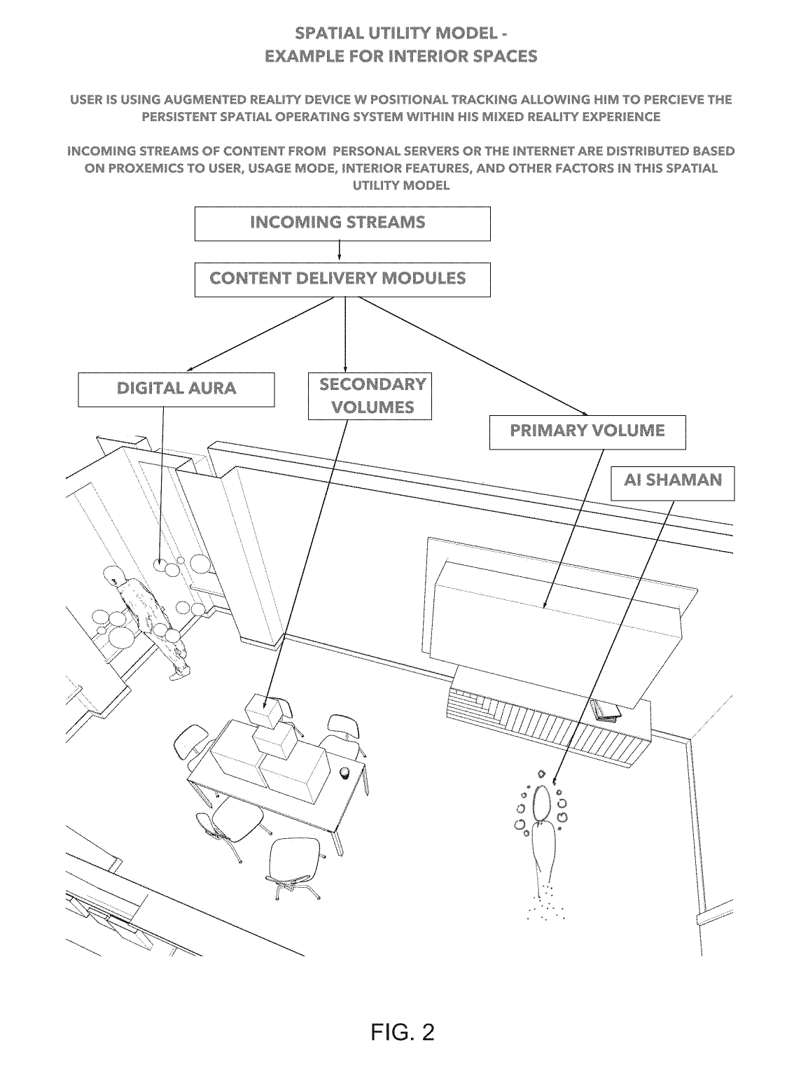

FIG. 2 is an illustration of one embodiment of the system showing a spatial utility model.

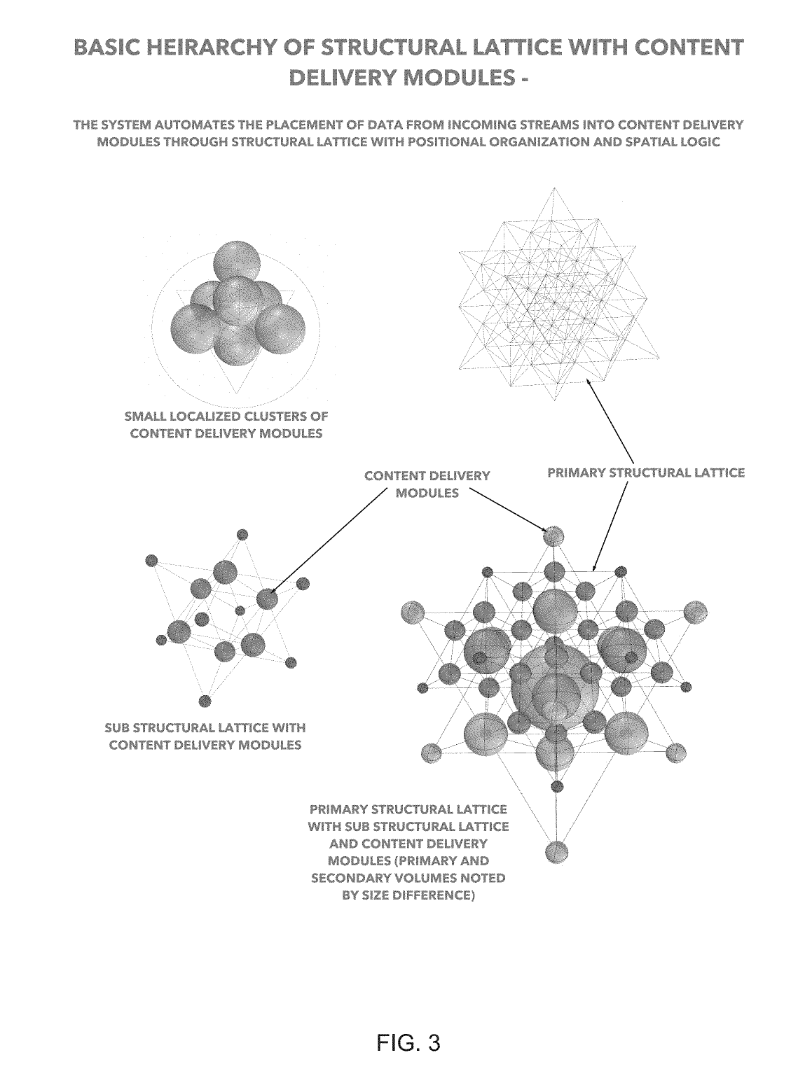

FIG. 3 is an illustration of one embodiment of the system showing basic hierarchy of structural lattice with content delivery modules.

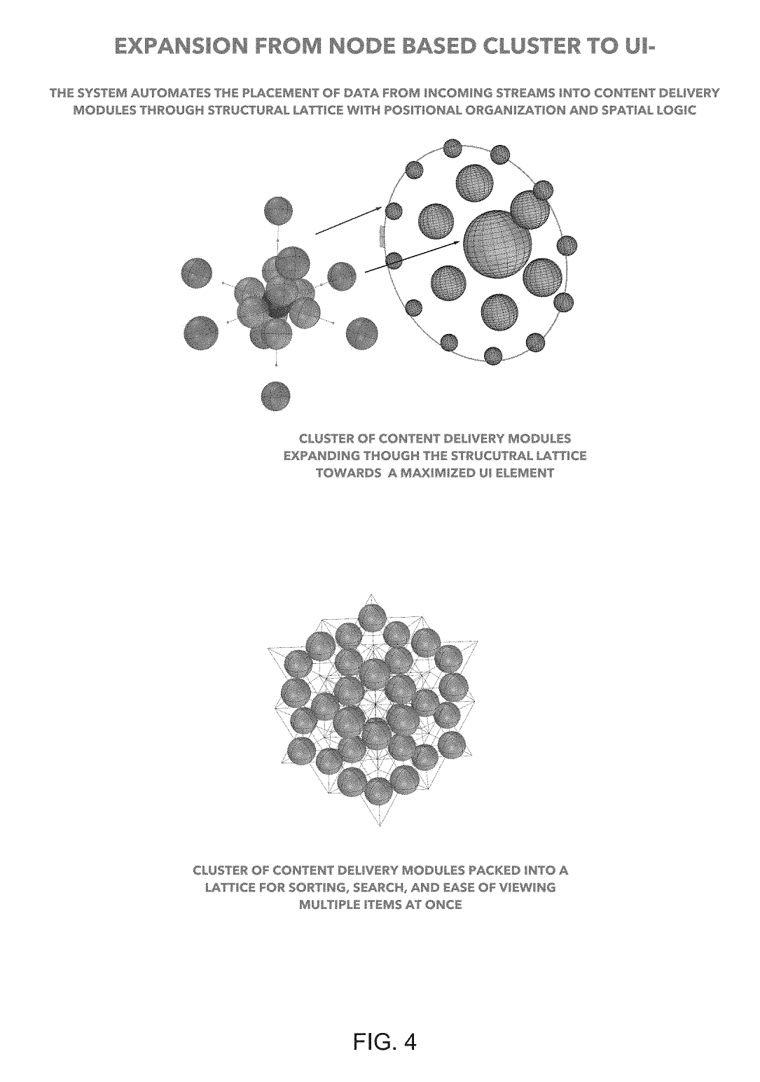

FIG. 4 is an illustration of one embodiment of the system showing expansion from node based cluster.

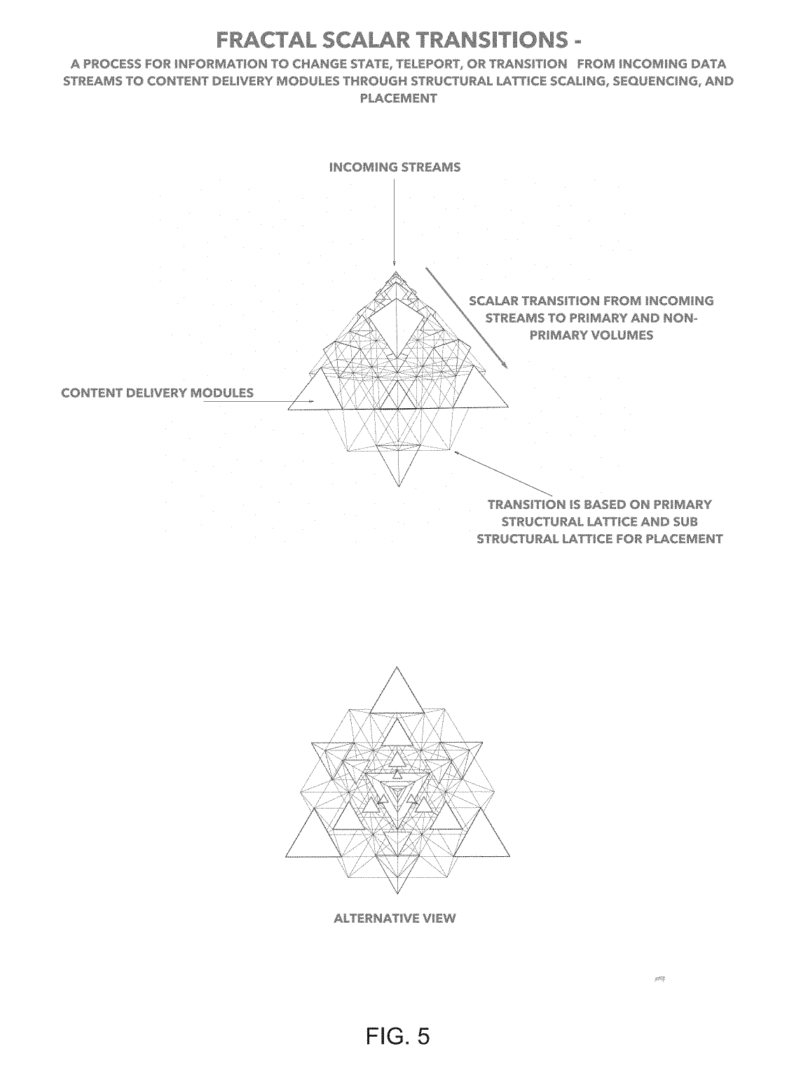

FIG. 5 is an illustration of one embodiment of the system showing a proxemics utility model.

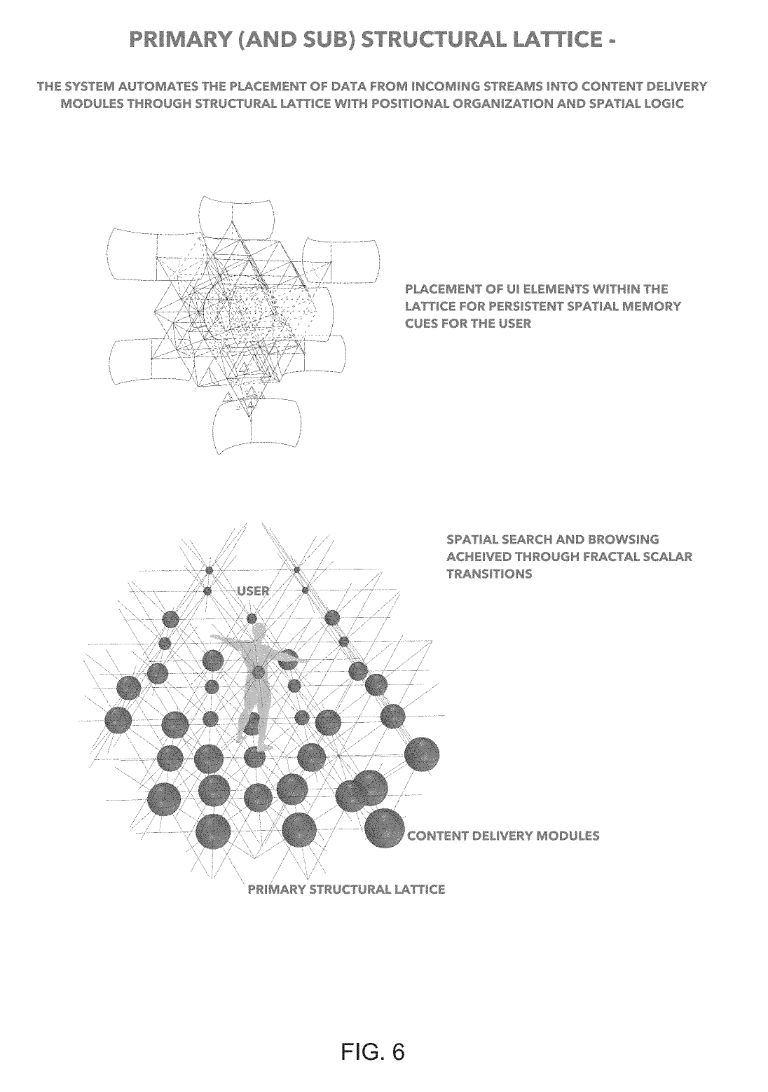

FIG. 6 is an illustration of one embodiment of the system showing another proxemics utility model.

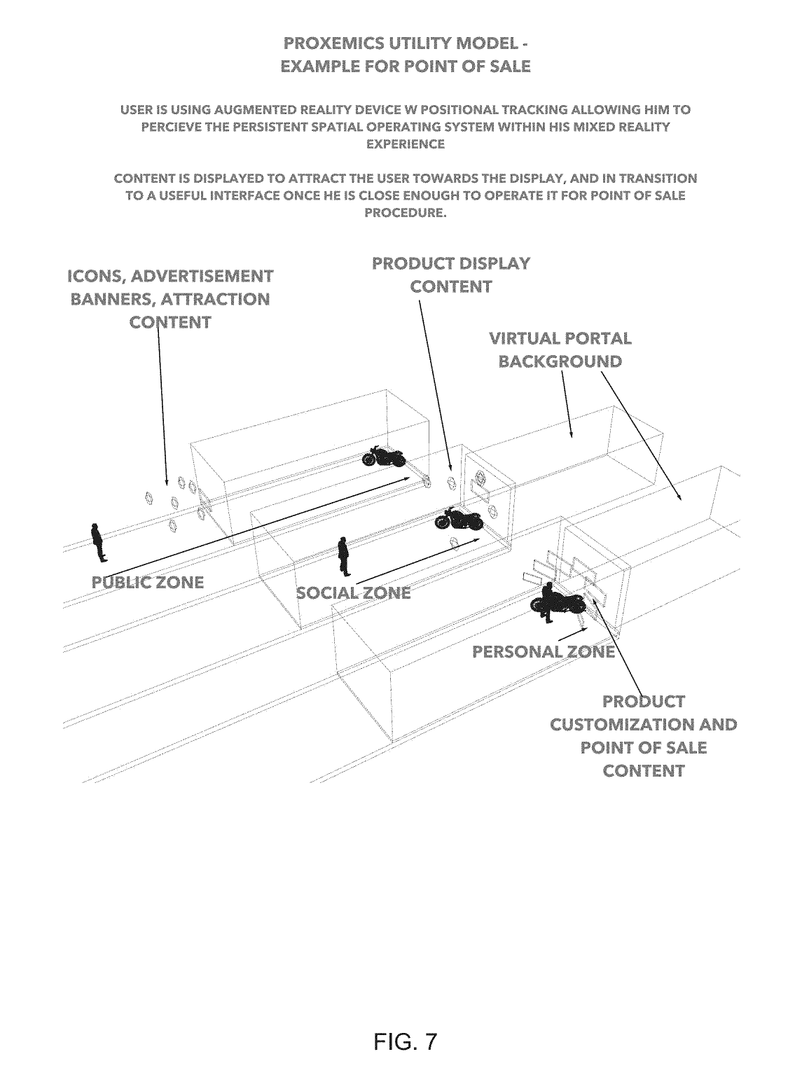

FIG. 7 is an illustration of one embodiment of the system showing fractal scalar transitions.

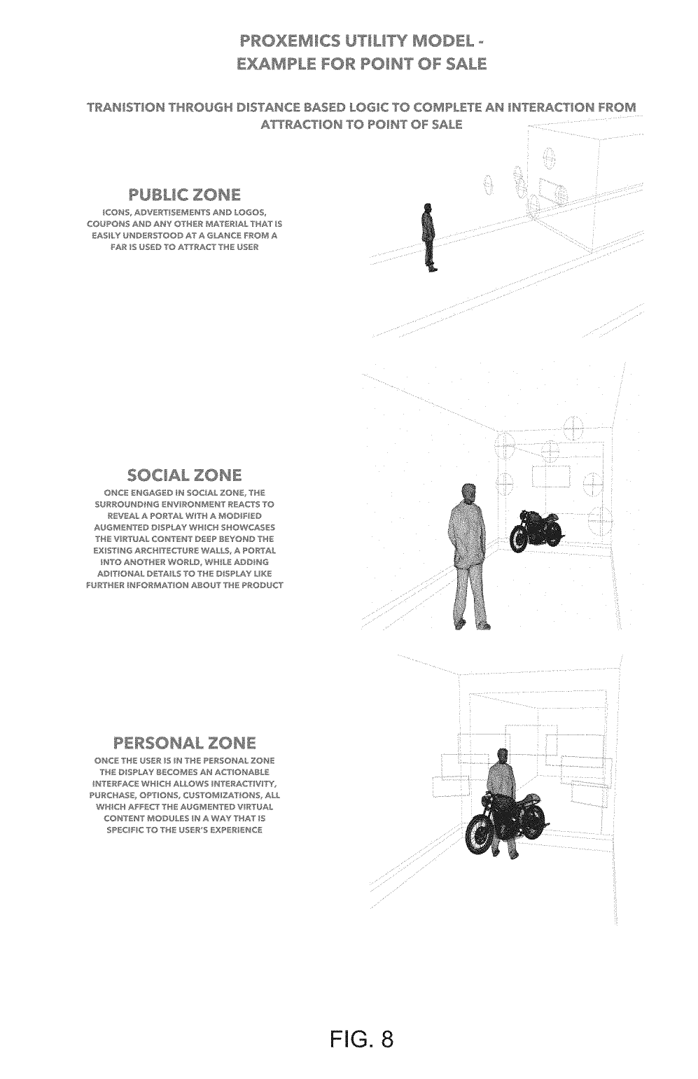

FIG. 8 is an illustration of one embodiment of the system showing primary and sub structural lattice.

### Architectural Interface Recognition (A.I.R.) Software for Augmented Reality Applications

The User: The User is the primary entity functioning with the content and content modules in the Augmented Reality Space.

The Content Module: A Content Module is the bounding volumetric container that holds a specific application, incident of media, interactive portal, or any piece of content or functioning digital component. The Content Module defines a spatial territory for the content to exist and be understood, recognized, and engaged by the User.

Content Module Group: A Content Module Group is a group of Content Modules that are related in a way that facilitates an organizational, functional, and/or aesthetic effect. These may be in a spatial, or hierarchical arrangement that allows for operational functions like browsing, searching, choosing, sorting, rating, or any other activity that grouping would be useful for.

The Digital Aura: Digital Aura is the organization of Content Modules around the User's body that are hero-centric and surround the body.

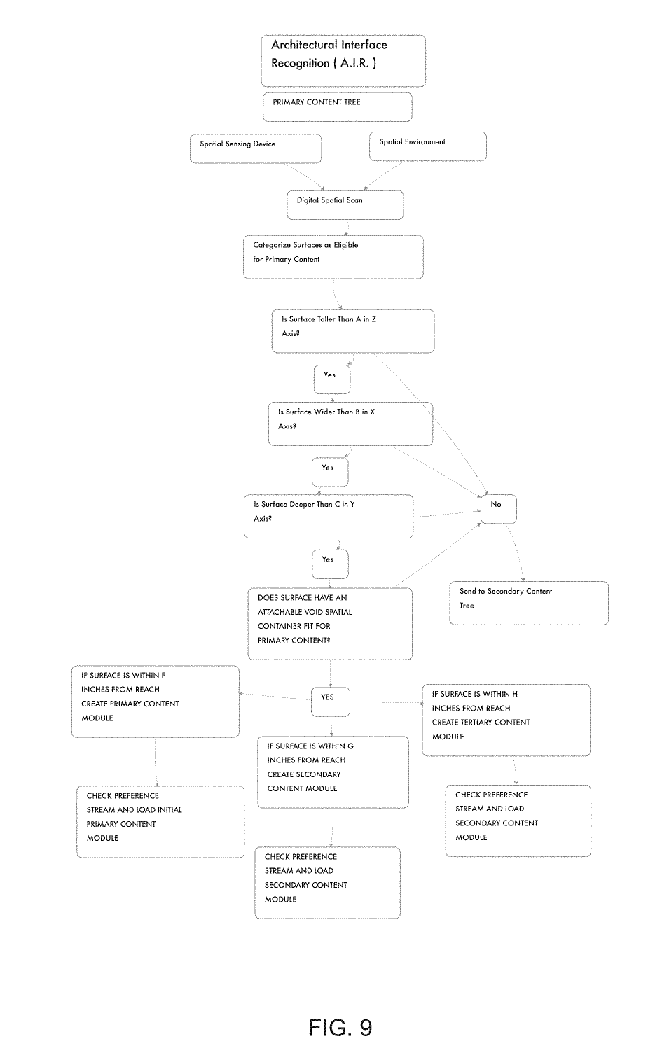

FIG. 9 is a flow diagram of one embodiment of an architectural interface recognition.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. The disclosed embodiments capable of modifications in various obvious aspects, all without departing from the spirit and scope of the protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope. It is intended that the scope or protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A spatial operating system with dynamic spatial utility model for virtual and augmented reality, comprising:
augmented reality or virtual reality interface devices;
digital user interface elements;
user interactions and/or gestures;
a dynamic utility model for inter-operable functions and component behaviors of the digital elements in space;
digital content modules;
input and output streams;
sensory data, sense data;
location data;
3d spatial data of a user's environment;
biometric data from the user's body; and
artificial intelligence algorithms;
wherein these components of the spatial operating system with dynamic spatial utility model for virtual and augmented reality are structured such that the user commands the operating system from within a virtual and/or augmented reality to achieve desired outcomes, processes, and effects in a digital spatial computing.

2. A system that provides a functioning utility for the interpretation and utilization of the spatial features of a persons surrounding environment for appropriate programmable elements of augmented reality experiences, the system comprising:
software that evaluates and interprets a spatial context to make decisions about where spatial content modules and interactive elements should be placed relative to the user(s);
the software performing the steps:
scanning the raw spatial data from the spatial context;
processing an algorithm that interprets surfaces and depths, and categorizes them appropriately;
saving the modules; and
integrating the content and functionality based on user parameters and operational modes.
